(19) United States
(12) Patent Application Publication
(10) Pub. No.: US 2024/0354917 A1
(43) Pub. Date: Oct. 24, 2024

(54) METHOD FOR DETECTING (RECOGNIZING) THE FACT OF PRESENTING A DIGITAL COPY OF A DOCUMENT IN THE FORM OF A SCREEN CAPTURE

(71) Applicant: Smart Engines Service, LLC, Moscow (RU)

(72) Inventors: Vladimir Viktorovich ARLAZAROV, Moscow (RU); Dmitrij Petrovich NIKOLAEV, Moscow (RU); Dmitrij Valerevich POLEVOJ, Moscow (RU); Dmitrij Gennadievich SLUGIN, Moscow (RU); Irina Andreevna KUNINA, Aleksandrovsky district (RU); Irina Vitalievna SIGAREVA, Izhevsk (RU)

(21) Appl. No.: 18/137,181

(22) Filed: Apr. 20, 2023

(51) Int. Cl. G06T 7/00; G06V 10/25; G06V 10/54; G06V 10/60; G06V 10/74

(52) U.S. Cl. CPC G06T 7/0002; G06V 10/25; G06V 10/54; G06V 10/60; G06V 10/761; G06T 2207/20036; G06T 2207/20061; G06T 2207/30176

(57) ABSTRACT

The present disclosure relates to computer technology for document security and authentication. Embodiments increase the accuracy and reliability of detecting (recognizing) the fact that a digital copy of a document has been presented in the form of a screen capture. An input image of a document, with known boundaries and internal structure, is received. Independent analysis of the specified areas of the document image is performed for certain anomalies that may occur from screen capture. When at least one of the anomalies is detected, the input image may be determined to be a digital copy instead of a physical document. The anomalies may be divided by the type of analyzed areas: analysis of the entire image of the document inside the localized boundaries; analysis of the image of the document boundaries; and/or a document area selected in accordance with the document's known structure.

### CROSS-REFERENCE TO RELATED APPLICATIONS

The present application claims priority to Russian Application No. 2021128626, filed on Sep. 30, 2021, which is hereby incorporated herein by reference as if set forth in full.

### BACKGROUND

### Field of the Invention

The present disclosure is generally directed to a method for protecting and authenticating documents, and, more particularly, to a method for detecting (recognizing) the fact of presenting a digital copy of a document in the form of a screen capture.

### Description of the Related Art

The prior art does not reveal any analogues and prototypes. All known methods are aimed at imaging three-dimensional scenes indoors and outdoors.

Methods aimed at detecting the fact of presenting a copy of an image received from a monitor can be divided into two groups. The first group aims to search for certain deformations to be found in a recaptured image (RI) but not presented in a single captured image (SCI). The second group is not aimed at searching for specific artifacts, only suggesting that the recapture of the image introduces some deviations from normal images.

Works from the first group are aimed at finding deformations, such as blurring, aliasing, color differences, etc. In Ref1, the authors use boundaries blurring to identify the RI. In Ref2, the authors detect the presence of a textured pattern, color anomalies, and the loss of fine details for classifying images on SCI and RI. In Ref3 and Ref4, the authors evaluate blurring as a result of JPEG double recompression, arguing that recaptured JPEG images are subject to double compression, which leads to image blocking artifacts and blurring. In Ref3, the authors also analyze the effects of aliasing, and in Ref4, the color differences between SCI and RI are additionally analyzed. Changes in color between SCI and RI are also analyzed in Ref2 and Ref5. In Ref6, to search for a periodic pattern arising due to aliasing, the authors use the theory and methods of cyclo-stationary processes.

The second group of methods includes Ref7, which does not make an assumption about the nature of artifacts. The attribute vector is formed by calculating the pixel-by-pixel correlation coefficients of an image divided into blocks. The authors of Ref8, motivated by the effectiveness of the approach proposed in Ref7, propose an approach based on improved residual correlation coefficients. In particular, this is justified by the fact that blurring and spectrum aliasing artifacts caused by recapturing are fuzzy in blurry and flat areas, using for calculation only blocks containing boundaries.

### SUMMARY

In an embodiment, a method comprises using at least one hardware processor to: receive an input image of a document with known boundaries and internal structure; analyze one or more areas of the document to detect whether any of the one or more areas contain at least one anomaly indicative of a screen capture of a digital copy of the document; when the at least one anomaly is detected, determine that the input image is an image of the digital copy of the document; and when the at least one anomaly is not detected, determine that the input image is an image of a physical copy of the document.

The one or more areas may comprise a first area that includes an entire area within the boundaries of the document. The at least one anomaly may comprise at least one set of parallel stripes within the first area.

Detecting whether the first area contains the at least one set of parallel stripes may comprise applying at least one morphological operation to the input image. Applying at least one morphological operation to the input image may comprise calculating:

$${I}_{1} = I - {I}_{0} \\ {I}_{2} = {I}_{c} - I \\ {I}_{res} = max ( {I}_{1} , {I}_{2} )$$

wherein I is the input image, I₀ is a result of applying a disconnection operation to input image I, I₀ is a result of applying a connection operation to input image I, and Iᵣₑₛ is an output image with a suppressed background. Iᵣₑₛ may be calculated for a filter window that is m pixels in width and n pixels in height to produce a first output image Iᵣₑₛ^{v}, and Iᵣₑₛ is calculated for a filter window that is n pixels in width and m pixels in height to produce a second output image Iᵣₑₛ^{h}, wherein n is greater than m.

Detecting whether the first area contains the at least one set of parallel stripes may further comprise, for each of the first output image Iᵣₑₛ^{v} and the second output image Iᵣₑₛ^{h}, for all possible lines in a range [−45°, 45° ], calculating a first Hough image Hₕ using a Fast Hough Transform, and for all possible lines in a range [45°, 135° ], calculating a second Hough image Hᵥ using the Fast Hough Transform. Detecting whether the first area contains the at least one set of parallel stripes may further comprise, for each line t in each first Hough image Hₕ and each second Hough image Hᵥ, calculating a sum of squared pixel values. The sum of squared pixel values may be calculated as:

$$ζ ( t ) = {{\sum }_{s} [ H ( s , t ) ]}^{2} .$$

At least one set of parallel stripes may be detected when a value of the sum of squared pixel values for any Hough image Hₕ or Hᵥ exceeds a predefined value.

The one or more areas may comprise a second area that includes the boundaries of the document. The at least one anomaly may comprise a threshold number of matching textures on opposing sides of one or more of the boundaries.

Detecting whether the second area contains the threshold number of matching textures on opposing sides of one or more of the boundaries may comprise, for each of the boundaries: producing a boundary image by selecting an area around the boundary and correcting a bevel of the boundary; normalizing a brightness of the boundary image; analyzing a texture of the normalized boundary image using a Fast Hough Transform; finding coinciding textures on opposing sides of the boundary based on the analysis; and counting the coinciding textures that are found as the number of matching textures.

Analyzing the texture may comprise, in each step of a sliding window across the normalized boundary image, for all possible lines in a range [−45°, 45° ], calculating a first Hough image Hₕ using a Fast Hough Transform, and for all possible lines in a range [45°, 135° ], calculating a second Hough image Hᵥ using the Fast Hough Transform. Analyzing the texture may further comprise, for each line t in each first Hough image Hₕ and each second Hough image Hᵥ, calculating a sum of squared gradients. Analyzing the texture may further comprise, for each line t in each first Hough image Hₕ and each second Hough image Hᵥ: determining a dominant direction of the texture based on the sum of squared gradients for the line t; assigning a confidence value to the dominant direction; and determining whether or not there is a coinciding texture on opposing sides of the boundary based on one or both of the dominant direction and the confidence value. The sum of squared gradients may be calculated as:

$$ζ ( t ) = {{\sum }_{s} [ H ( s , t ) - H ( s - 1 , t ) ]}^{2} .$$

The one or more areas may comprise a third area that is selected in accordance with the internal structure, wherein the at least one anomaly comprises an indication of color heterogeneity exceeding a predefined value.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIGS. 1A-1C illustrate an example of anomaly detection in a first area, according to an embodiment;

FIGS. 2A-2F illustrate an example of anomaly detection in a second area, according to an embodiment;

FIG. 3 illustrates an example of anomaly detection in a third area, according to an embodiment;

FIG. 4 illustrates an example process for detecting (recognizing) the fact that a digital copy of a document has been presented in the form of a screen capture, according to an embodiment; and

FIG. 5 illustrates an example processing system that may be used, according to an embodiment.

### DETAILED DESCRIPTION

Unlike the algorithms given above, the method proposed in this application takes into account both the specifics of the video-stream frames received from small-format digital cameras and the specifics of the analyzed object (the image of the document itself). First, inaccurate camera focusing or camera shifting in relation to the document, during the exposure, leads to blurring or smearing of the image, due to which the application of methods focusing on the blurring of the objects in the image will lead to false positives. Secondly, the complex inhomogeneous background of the document itself makes global approaches, such as analysis of texture or color differences, extremely unreliable. The holographic security elements of the document can be considered a color anomaly, and the automatic alteration in white balance and the strong variability of possible light sources will lead to the fact that the image of the same document will look completely different on different frames. At that, the global analysis of textured patterns will give false positives on the image of a document with a periodic pattern.

Holographic elements also render algorithms, which analyze the difference between the statistics in the spatial domain of RI and SCI, unstable. The method proposed in the application does not depend on the format of the input data.

Thus, the objective of disclosed embodiments is to provide a method for detecting (recognizing) the fact of presenting a digital copy of a document in the form of a screen capture. The aim is to achieve a technical result that comprises one or more of the following:
a) taking into account the specifics of the video-stream frames received from small-format digital cameras, as well as the features of the analyzed object;
b) improving accuracy and reliability; and/or
c) independence from the input data format, etc.

In an embodiment, the method is aimed at detecting the fact of capturing the presented document from the screen of a computer monitor. It is assumed that when the document is recaptured, there will be specific distortions that are not typical for a single-captured image.

The system accepts as input an image of a document, the boundaries and internal structure of which are considered as known. The boundaries of the localized document do not necessarily coincide with the boundaries of the input image. Further, the system independently analyzes specific areas of the document image for certain anomalies, the occurrence of which is possible when capturing from the screen. To decide if the input image is a digital copy instead of a physical document, it is sufficient to identify at least one of the specified types of anomalies.

The anomalies analyzed by the system are divided by the type of analyzed areas: analysis of the entire document image inside the localized boundaries (A1), the image of the document boundaries (A2), or the document zone (A3), selected in accordance with the known structure of the document. The algorithm developed for each of these types of area is described in greater detail below.

### A1. Stripe Detector

Analyzing the entire area of the document image inside the boundaries found.

To highlight the stripes and suppress the background, the considered area is subjected to the following sequence of morphological operations:

$${I}_{1} = I - {I}_{0} , {I}_{2} = {I}_{c} - I , {I}_{res} = max ( {I}_{1} , {I}_{2} )$$

wherein I₀ is the result of applying the disconnection or “erosion” morphological operation to image I, I_{c} is the connection or “dilation” morphological operation to image I, and Iᵣₑₛ is the output image with suppressed background.

Two results of the proposed filtering are considered in parallel: the result Iᵣₑₛ^{v} with a filter window 3 pixels wide and 1 pixel high, and the result Iᵣₑₛ^{h} with a window 1 pixel wide and 3 pixels high. Further, for all possible lines in the ranges [−45°, 45° ] and [45°, 135° ] two Hough images Hₕ and Hᵥ of the images Iᵣₑₛ^{h} and Iᵣₑₛ^{v}, respectively, are calculated using the fast Hough transform.

Further, in each line t of each resulting Hough image, the sum of squared pixel values is calculated:

$$ζ ( t ) = {{\sum }_{s} [ H ( s , t ) ]}^{2}$$

If the value of ζ(t) for the considered Hough image H exceeds some fixed value, it means that parallel stripes are detected on the image, i.e. the image contains an anomaly.

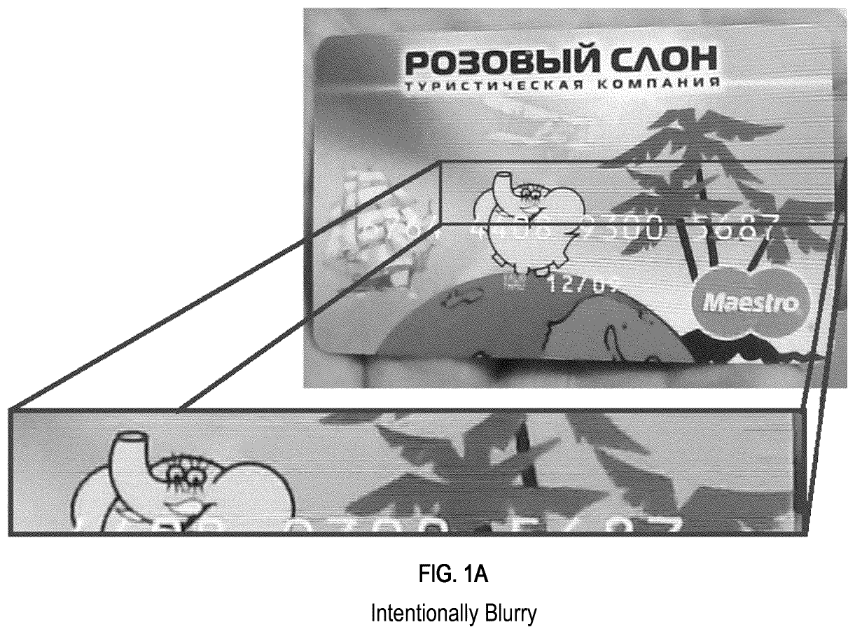

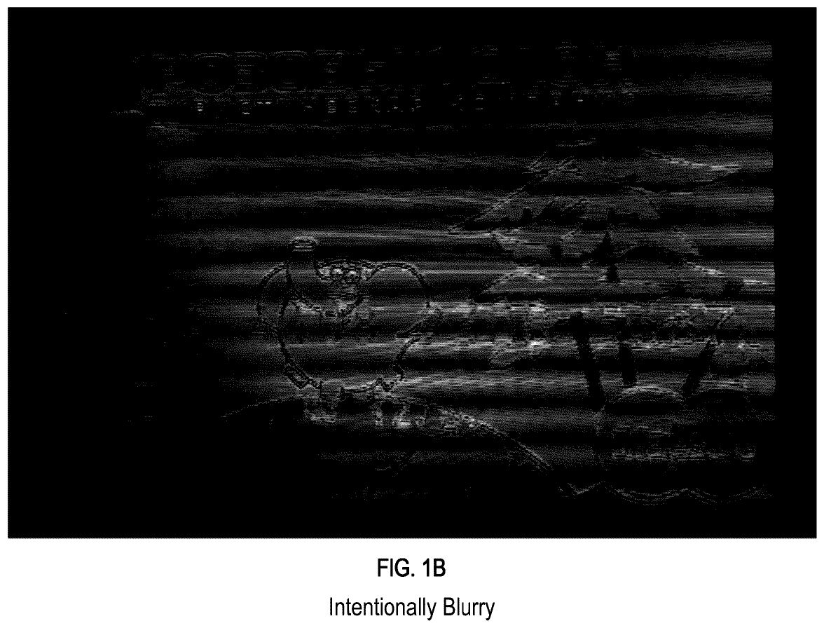

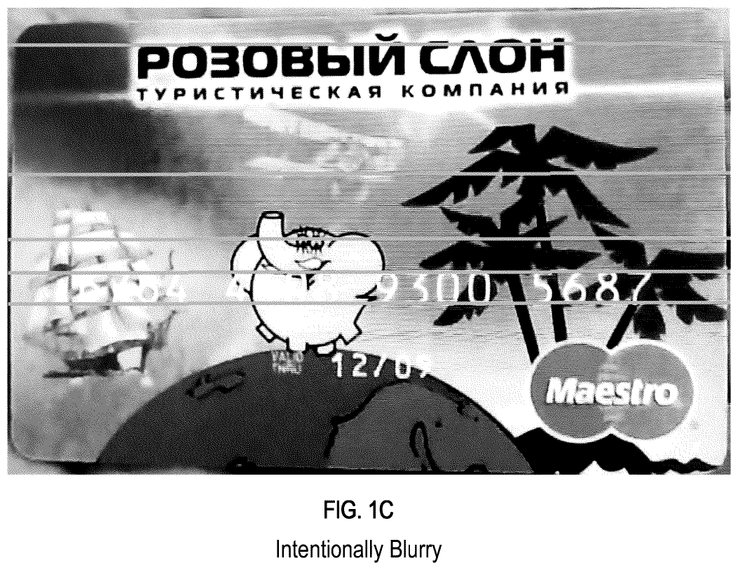

FIG. 1A presents an example of a document with the sought type of anomaly, FIG. 1B presents an example of the result of selecting stripes using the proposed morphological operations, and FIG. 1C presents an example of a visualization of the result of the detector operation with color indicating the directions of the first five stripes, according to an embodiment.

### A2. Texture Detector

On the input image, the detector highlights around each boundary of the document some area of a rectangular shape and analyzes the obtained areas for any periodic pattern with a clear orientation inside of them, which is identical on both sides of a particular boundary of the document. The Fast Hough Transform (FHT) is used for detecting such a pattern and its orientation.

An anomaly is considered detected if it is found for at least one border of the document.

### 1. Selecting the Area Around the Boundary on the Input Image and Correcting the Bevel of the Boundary.

For a given document boundary with coordinates of the start p_{b}=(x_{b}, y_{b}) and the end pₑ=(xₑ, yₑ), a convex quadrangle Q is calculated with vertices p_{b}+pₛ, pₑ+pₛ, pₑ−pₛ, p_{b}−pₛ in coordinates of input image I. Here pₛ=(w·sin α, w·cos α), wherein α is the angle of inclination of the boundary on the image relative to the X axis, and w is the indent step from the boundary in the direction of the normal, specified by the configuration.

Next, the resulting quadrangle Q is truncated to a smaller quadrangle Q′ along the axis coinciding with the document boundary, if Q is outside the boundaries of the image. If Q lies entirely within the area of image I, then Q′ will be equal to Q.

Next, the image area described by the Q′ sides is rotated by 90° if the orientation of the document boundary on the original image is within the range [45°, 135° ] relative to the X axis and is normalized using a bevel transformation so that the document boundary becomes parallel to the image lines.

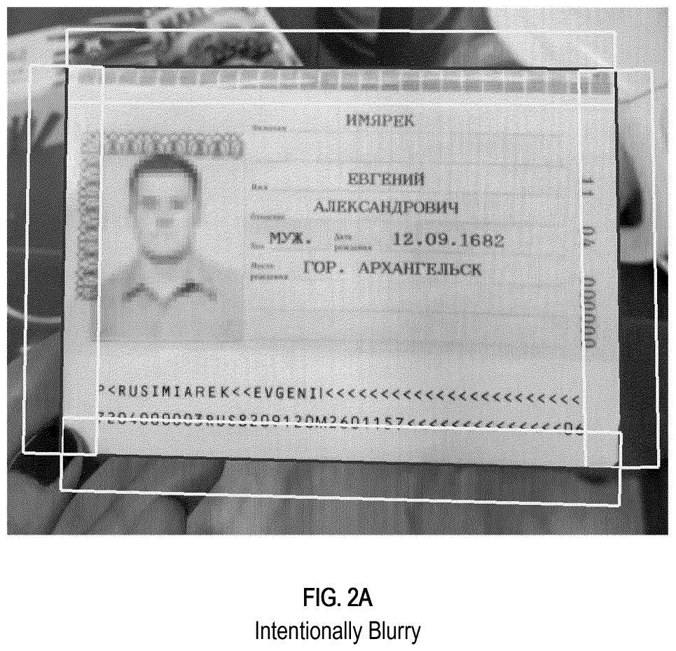

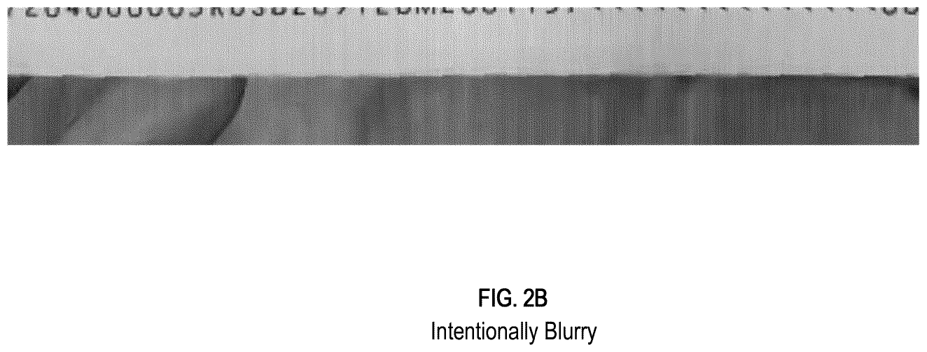

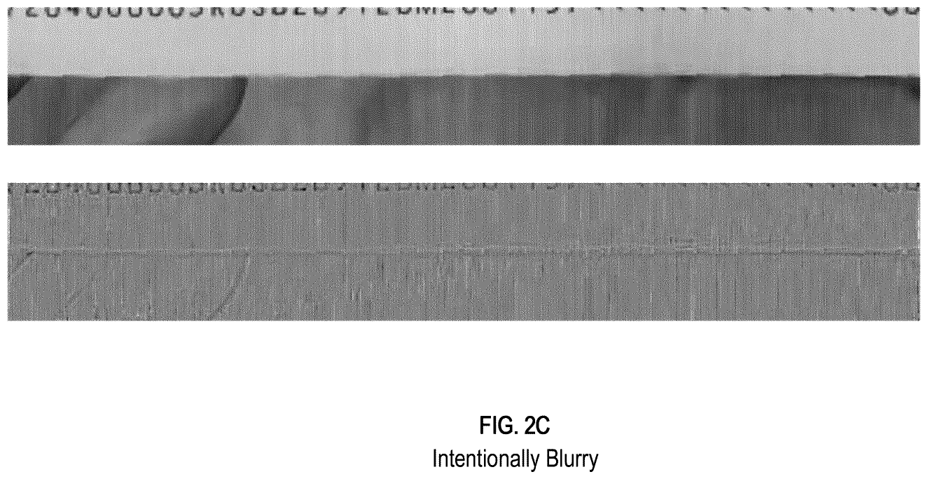

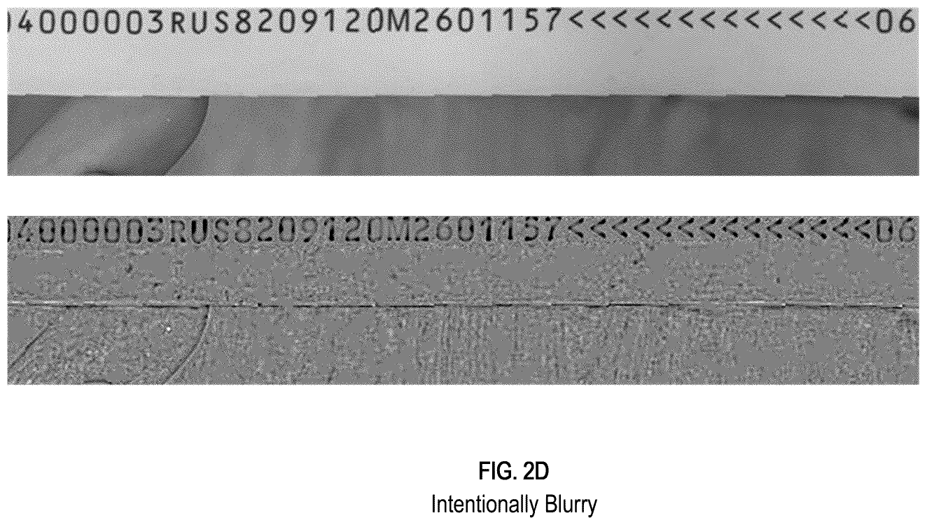

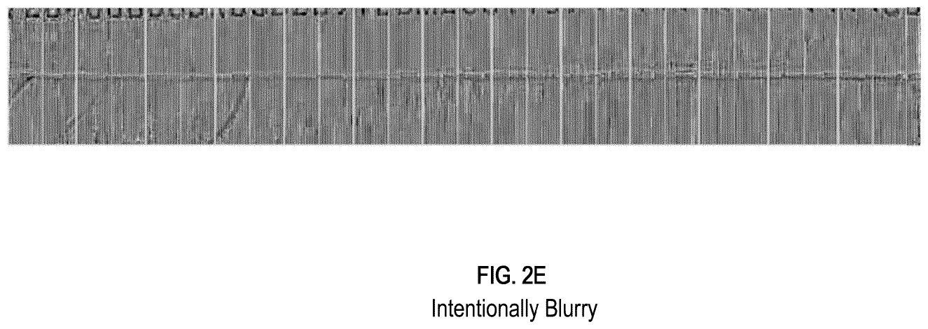

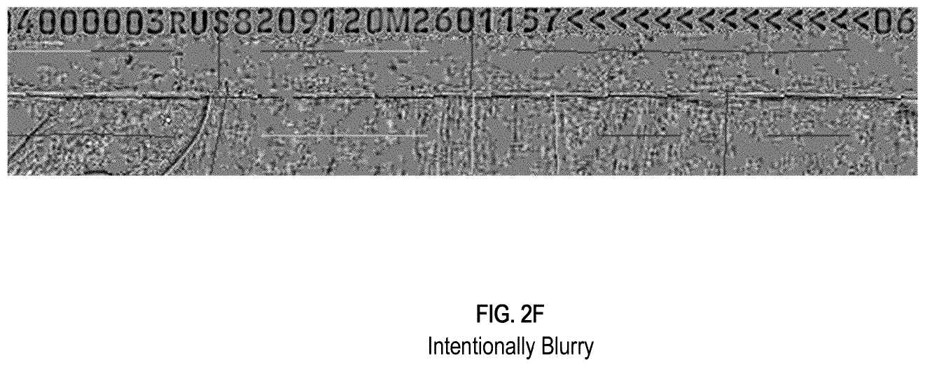

The resulting normalized image is truncated to a rectangle with a height of 2w, where one of the symmetry axes is the considered document boundary (see FIG. 2A). The obtained geometrically normalized image of the boundary I_{bound(j)} is transferred as input to the next stage.

2. Brightness normalization of the boundary image.

The essence of the normalization is to align the image in terms of brightness, while preserving the brightness gradients due to the texture.

Let I_{bound(j)} be the boundary image after geometric normalization of the bevel. Iₘ is the result of median I_{bound(j)} image filtering, I_{d}−|I_{bound(j)}−Iₘ| is the difference of the corresponding pixels of the images I_{bound(j)} and Iₘ, taken with a modulus sign, I_{dm} is the result of median filtering I_{d}. Then the normalized Iₙₒᵣₘ₍ⱼ₎ image is calculated as:

$${I}_{norm ( j )} = ( {P}_{1} - {P}_{2} ) \frac{{I}_{bound ( j )} - {I}_{m}}{{I}_{dm}} + {P}_{2}$$

wherein P₁ and P₂ are configurable brightness values (see FIG. 2B).
3. Texture Analysis with FHT.

The normalized image Iₙₒᵣₘ₍ⱼ₎ is processed by a sliding square window with side w and step w. For each new window position, two Hough images Hₕ and Hᵥ are calculated for all possible lines in the ranges [−45°,45° ] and [45°, 135° ], respectively, using FHT. Further, in each line t of each resulting Hough image, the sum of squared gradients is calculated:

$$ζ ( t ) = {{\sum }_{s} [ H ( s , t ) - H ( s - 1 , t ) ]}^{2}$$

The dominant direction of the texture is the direction corresponding to the line with the corresponding index:

$${t}_{o} = {arg max}_{{t}_{1} , {t}_{2}} {ζ}_{h} ( {t}_{1} ) ⋃ {ζ}_{v} ( {t}_{2} )$$

The resulting direction is assigned a confidence factor:

$$conf = 1 - \frac{max {ζ}_{h} ( {t}_{1} )}{max {ζ}_{v} ( {t}_{2} )} , \\ conf = 1 - \frac{max {ζ}_{v} ( {t}_{2} )}{max {ζ}_{h} ( {t}_{1} )} ,$$

if the dominant direction is vertical; or
if the dominant direction is horizontal.

### 4. Finding a Matching Structure.

If for two found directions in the windows with upper left vertices (x, y) and (x, y+w) the conditions |t₀₁-t₀₂|≤t_{ε} and |conf₁-conf₂|≤conf_{ε}∪min(ζₕ(t₀₁), ζₕ(t₀₂))≥ζ_{ε} are satisfied, then the matching structure for the considered x-position is considered to be found. Here, t₀ᵢ is found in the i-th window t₀, and confᵢ is the confidence factor for t₀ᵢ.

If there are more such coinciding structures for different x than the value (e.g., threshold) set by the configuration, then the anomaly is considered to be detected for the boundary, and, therefore, it is detected for the entire image.

FIG. 2A presents the input image, on which the found document boundaries are marked with red lines, and the Q′ zone with a width of 2w is marked with yellow, where w is the indent step from the boundary in the direction of the normal, and FIG. 2B presents the lower boundary after bevel normalization.

FIG. 2C presents the source image of the boundary with normalized brightness for a digital copy of the document, and FIG. 2D presents the source image of the boundary with normalized brightness for a physical document.

FIGS. 2E and 2F presents the visualization of detecting a matching structure for a digital copy of the document and the physical document, respectively. Here, cyan color marks the areas of the image with a width w and a height of 2w, for which a matching texture was found on both sides of the boundary (anomaly). The remaining colors visualize the texture directions found and the confidence in the answer. Here green corresponds to the confidence factor close to 1, and red and orange correspond to the confidence factor close to 0.

### A3. False Color Detector

The detector is based on the assumption that the coloring of the document within the considered area of the document should be predominantly homogeneous.

The first step is checking the distribution of the color tone within the area of the considered image area: a histogram of the color tone is built and it is checked in which interval the specified proportion of the histogram values lies. Saturation S and hue H are calculated using the following formulas:

$$S = max ( R , G , B ) - min ( R , G , B ) \\ H = \{ \begin{matrix}undefined & if MAX = MIN \\ 60 ° \times \frac{G - B}{MAX - MIN} + 0 ° , & if MAX = R and G \geq B \\ 60 ° \times \frac{G - B}{MAX - MIN} + 360 ° , & if MAX = R and G < B \\ 60 ° \times \frac{B - R}{MAX - MIN} + 120 ° , & if MAX = G \\ 60 ° \times \frac{R - G}{MAX - MIN} + 240 ° , & if MAX = B\end{matrix}$$

For all determined values of H, the hue histogram is calculated if the values of S corresponding to them lie within a certain range set by the configuration [sₘᵢₙ, sₘₐₓ], and it is checked what is the value of the segment in which the specified proportion of the histogram values lies. If the segment is small relative to the set one, then it is considered that the area is colored predominantly homogeneously and contains no considered anomalies under.

If the segment is large, the constructed saturation map is binarized using the Niblack method. Next, on the resulting binary image, the connectivity components are searched and filtered by area (this is done for the case of a possible violation of the color homogeneousness by holograms of a known size), and for the remaining connectivity components, it is calculated what proportion of the total image area they occupy. If such a proportion exceeds a certain critical value, then it is considered that the anomaly has been detected, otherwise it is considered not detected.

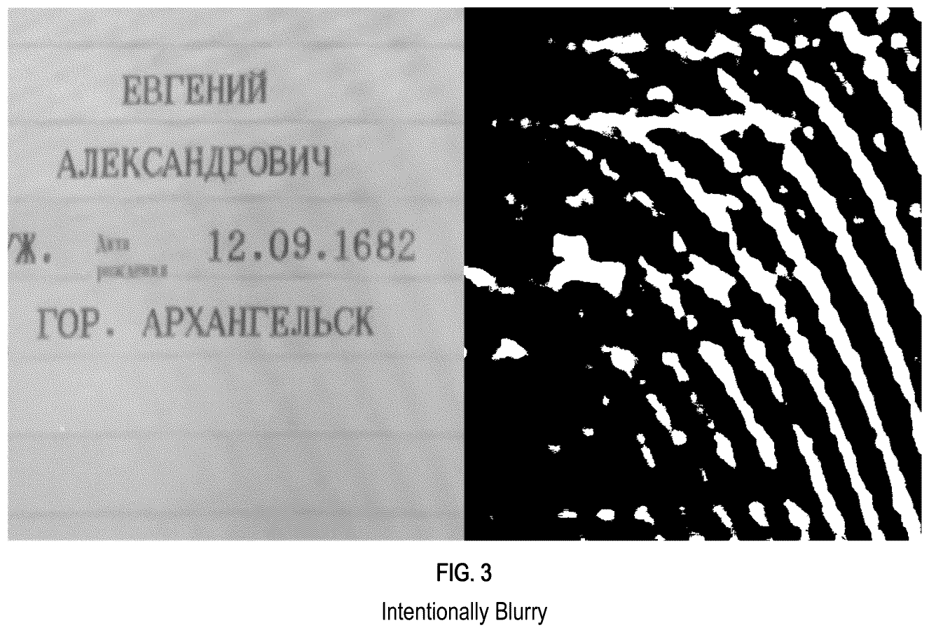

FIG. 3 presents an example of the considered area of the document (on the left) and the result of binarization of its saturation map (on the right).

### Example Process

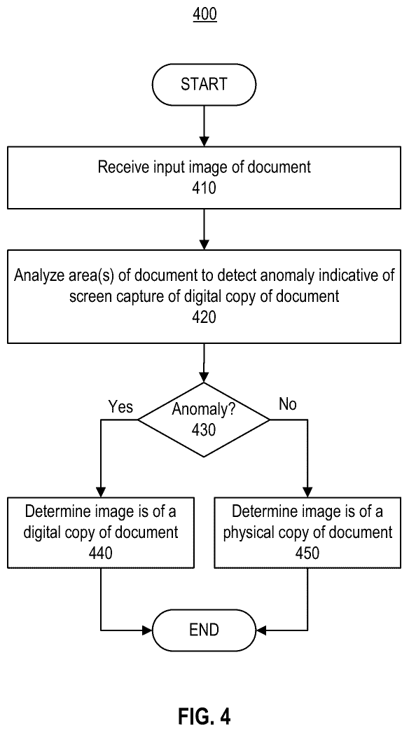

FIG. 4 illustrates an example process 400 for detecting (recognizing) the fact that a digital copy of a document has been presented in the form of a screen capture, according to an embodiment.

Initially, in subprocess 410, an input image of a document is received. One or more parameters of the input image may be known in advance of process 400. These parameter(s) may include, without limitation, the boundaries of the document in the input image, the internal structure of the document in the image, and/or the like. The parameter(s) may be determined in any suitable manner.

In subprocess 420, one or more areas of the document in the input image are analyzed to detect whether any of the area(s) contain at least one anomaly indicative of a screen capture of a digital copy of the document. In an embodiment, the one or more areas may be a plurality of areas, such as the areas A1, A2, and/or A3, described herein. The analysis may include any of the analyses described herein with respect to areas A1, A2, and/or A3.

In subprocess 430, it is determined whether or not at least one anomaly was detected in subprocess 420. In an embodiment, the determination is that the at least one anomaly was detected (i.e., “Yes” in subprocess 430) when any one anomaly is detected in subprocess 420 (e.g., in area A1, A2, or A3). Alternatively, the determination is that at least one anomaly was detected (i.e., “Yes” in subprocess 430), when a certain number and/or combination of anomalies are detected in subprocess 420 (e.g., anomalies in areas A1 and A2, A2 and A3, A1 and A2 and A3, etc.). When the determination is that at least one anomaly is detected (i.e., “Yes” in subprocess 430), process 400 proceeds to subprocess 440. Otherwise, when the determination is that at least one anomaly is not detected (i.e., “No” in subprocess 430), process 400 proceeds to subprocess 450.

In subprocess 440, it is determined that the input image is of a digital copy of the document. In this case, process 400 may output an indication that the input image is of a digital copy of the document, so that an appropriate action can be taken by one or more downstream functions. An appropriate action may include, without limitation, rejecting an attempt to use the document (e.g., for identity verification), sending an alert to at least one recipient, and/or the like.

In subprocess 450, it is determined that the input image is of a physical copy of the document. In this case, process 400 may output an indication that the input image is of a physical copy of the document, so that an appropriate action can be taken by one or more downstream functions. An appropriate action may include, without limitation, accepting the document for identity verification, triggering an identity verification process, and/or the like.

### Example Processing System

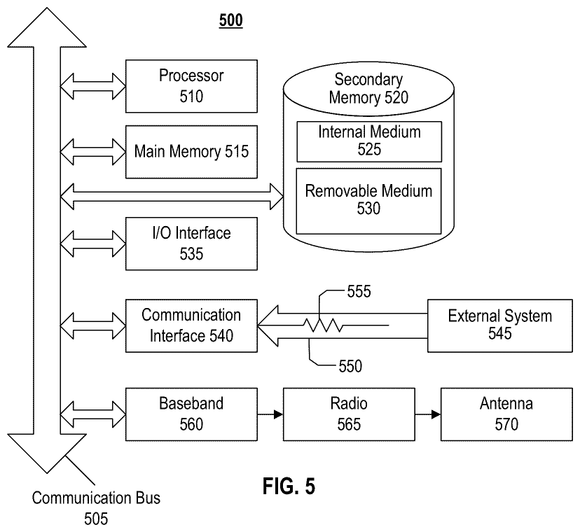

FIG. 5 is a block diagram illustrating an example wired or wireless system 500 that may be used in connection with various embodiments described herein. For example, system 500 may be used as or in conjunction with one or more of the processes, methods, or functions (e.g., to store and/or execute one or more software modules) described herein, including to store and/or execute software implementing process 400. System 500 can be any processor-enabled device (e.g., server, personal computer, etc.) that is capable of wired or wireless data communication. Other processing systems and/or architectures may also be used, as will be clear to those skilled in the art.

System 500 may comprise one or more processors 510. Processor(s) 510 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 510. Examples of processors which may be used with system 500 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 510 may be connected to a communication bus 505. Communication bus 505 may include a data channel for facilitating information transfer between storage and other peripheral components of system 500. Furthermore, communication bus 505 may provide a set of signals used for communication with processor 510, including a data bus, address bus, and/or control bus (not shown). Communication bus 505 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 500 may comprise main memory 515. Main memory 515 provides storage of instructions and data for programs executing on processor 510, such as one or more of the functions and/or modules discussed herein. It should be understood that programs stored in the memory and executed by processor 510 may be written and/or compiled according to any suitable language, including without limitation C/C++, Java, JavaScript, Perl, Python, Visual Basic, NET, and the like. Main memory 515 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 500 may comprise secondary memory 520. Secondary memory 520 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 500. The computer software stored on secondary memory 520 is read into main memory 515 for execution by processor 510. Secondary memory 520 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 520 may include an internal medium 525 and/or a removable medium 530. Removable medium 530 is read from and/or written to in any well-known manner. Removable storage medium 530 may be, for example, a magnetic tape drive, a compact disc (CD) drive, a digital versatile disc (DVD) drive, other optical drive, a flash memory drive, and/or the like.

System 200 may comprise an input/output (I/O) interface 535. I/O interface 535 provides an interface between one or more components of system 500 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 500 may comprise a communication interface 540. Communication interface 540 allows software to be transferred between system 500 and external devices (e.g. printers), networks, or other information sources. For example, computer-executable code and/or data may be transferred to system 500, over one or more networks (e.g., including the Internet), from a network server via communication interface 540. Examples of communication interface 540 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 500 with a network or another computing device. Communication interface 540 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 540 is generally in the form of electrical communication signals 555. These signals 555 may be provided to communication interface 540 via a communication channel 550 between communication interface 540 and an external system 545. In an embodiment, communication channel 550 may be a wired or wireless network, or any variety of other communication links. Communication channel 550 carries signals 555 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 515 and/or secondary memory 520. Computer-executable code can also be received from an external system 545 via communication interface 540 and stored in main memory 515 and/or secondary memory 520. Such computer-executable code, when executed, enable system 500 to perform the various functions of the disclosed embodiments as described elsewhere herein.

In an embodiment that is implemented using software, the software may be stored on a computer-readable medium and initially loaded into system 500 by way of removable medium 530, I/O interface 535, or communication interface 540. In such an embodiment, the software is loaded into system 500 in the form of electrical communication signals 555. The software, when executed by processor 510, preferably causes processor 510 to perform one or more of the processes and functions described elsewhere herein.

System 500 may comprise wireless communication components that facilitate wireless communication over a voice network and/or a data network (e.g., in the case of a mobile device, such as a smart phone). The wireless communication components comprise an antenna system 570, a radio system 565, and a baseband system 560. In system 500, radio frequency (RF) signals are transmitted and received over the air by antenna system 570 under the management of radio system 565.

In an embodiment, antenna system 570 may comprise one or more antennae and one or more multiplexors (not shown) that perform a switching function to provide antenna system 570 with transmit and receive signal paths. In the receive path, received RF signals can be coupled from a multiplexor to a low noise amplifier (not shown) that amplifies the received RF signal and sends the amplified signal to radio system 565.

In an alternative embodiment, radio system 565 may comprise one or more radios that are configured to communicate over various frequencies. In an embodiment, radio system 565 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 565 to baseband system 560.

If the received signal contains audio information, then baseband system 560 decodes the signal and converts it to an analog signal. Then the signal is amplified and sent to a speaker. Baseband system 560 also receives analog audio signals from a microphone. These analog audio signals are converted to digital signals and encoded by baseband system 560. Baseband system 560 also encodes the digital signals for transmission and generates a baseband transmit audio signal that is routed to the modulator portion of radio system 565. The modulator mixes the baseband transmit audio signal with an RF carrier signal, generating an RF transmit signal that is routed to antenna system 570 and may pass through a power amplifier (not shown). The power amplifier amplifies the RF transmit signal and routes it to antenna system 570, where the signal is switched to the antenna port for transmission.

Baseband system 560 is communicatively coupled with processor(s) 510, which have access to memory 515 and 520. Thus, software can be received from baseband processor 560 and stored in main memory 510 or in secondary memory 520, or executed upon receipt. Such software, when executed, can enable system 500 to perform the various functions of the disclosed embodiments.

### REFERENCES

Ref1: Thongkamwitoon T., Muammar H., Dragotti P. L. An image recapture detection algorithm based on learning dictionaries of edge profiles//IEEE Transactions on Information Forensics and Security.—2015.—T. 10.—No. 5.—C. 953-968. 2. Cao H., Kot A. C. Identification of recaptured photographs on LCD screens//2010 IEEE International Conference on Acoustics, Speech and Signal Processing.—IEEE, 2010.—C. 1790-1793. 3. Li R., Ni R., Zhao Y. An effective detection method based on physical traits of recaptured images on LCD screens//International Workshop on Digital Watermarking.—Springer, Cham, 2015.—C. 107-116. 4. Ni R., Zhao Y., Zhai X. Recaptured images forensics based on color moments and DCT coefficients features//J. Inf. Hiding Multimedia Signal Process.—2015.—T. 6.—N22.—C. 323-333. 5. Gao X. et al. Single-view recaptured image detection based on physics-based features//2010 IEEE International Conference on Multimedia and Expo.—IEEE, 2010.—C. 1469-1474. 6. Mahdian B., Saic S. Identification of aliasing-based patterns in recaptured LCD screens//2015 IEEE International Conference on Image Processing (ICIP).—IEEE, 2015.—C. 616-620. 7. Wang K. A simple and effective image-statistics-based approach to detecting recaptured images from LCD screens //Digital Investigation.—2017.—T. 23.—C. 75-87. 8. Zhu N., Li Z. Recaptured image detection through enhanced residual-based correlation coefficients//International Conference on Cloud Computing and Security.—Springer, Cham, 2018.—C. 624-634. (57 1. Thongkamwitoon T., Muammar H., Dragotti P. L. An image recapture detection algorithm based on learning dictionaries of edge profiles//IEEE Transactions on Information Forensics and Security.—2015.—T. 10.—No5.-C. 953-968.
Ref2: Cao H., Kot A. C. Identification of recaptured photographs on LCD screens//2010 IEEE International Conference on Acoustics, Speech and Signal Processing.—IEEE, 2010.—C. 1790-1793.
Ref3: Li R., Ni R., Zhao Y. An effective detection method based on physical traits of recaptured images on LCD screens//International Workshop on Digital Watermarking.—Springer, Cham, 2015.—C. 107-116.
Ref4: Ni R., Zhao Y., Zhai X. Recaptured images forensics based on color moments and DCT coefficients features//J. Inf. Hiding Multimedia Signal Process.—2015.—T. 6.—No2.—C. 323-333.
Ref5: Gao X. et al. Single-view recaptured image detection based on physics-based features//2010 IEEE International Conference on Multimedia and Expo.—IEEE, 2010.—C. 1469-1474.
Ref6: Mahdian B., Novozimsky A., Saic S. Identification of aliasing-based patterns in recaptured LCD screens//2015 IEEE International Conference on Image Processing (ICIP). —IEEE, 2015.—C. 616-620.
Ref7: Wang K. A simple and effective image-statistics-based approach to detecting recaptured images from LCD screens//Digital Investigation.—2017.—T. 23.—C. 75-87.
Ref8: Zhu N., Li Z. Recaptured image detection through enhanced residual-based correlation coefficients//International Conference on Cloud Computing and Security.—Springer, Cham, 2018.—C. 624-634.

What is claimed is:

1. A method comprising using at least one hardware processor to:
receive an input image of a document with known boundaries and internal structure;
analyze one or more areas of the document to detect whether any of the one or more areas contain at least one anomaly indicative of a screen capture of a digital copy of the document;
when the at least one anomaly is detected, determine that the input image is an image of the digital copy of the document; and
when the at least one anomaly is not detected, determine that the input image is an image of a physical copy of the document.

2. The method of claim 1, wherein the one or more areas comprise a first area that includes an entire area within the boundaries of the document.

3. The method of claim 2, wherein the at least one anomaly comprises at least one set of parallel stripes within the first area.

4. The method of claim 3, wherein detecting whether the first area contains the at least one set of parallel stripes comprises applying at least one morphological operation to the input image.

5. The method of claim 4, wherein applying at least one morphological operation to the input image comprises calculating:
$${I}_{1} = I - {I}_{0} \\ {I}_{2} = {I}_{c} - I \\ {I}_{res} = max ( {I}_{1} , {I}_{2} )$$
wherein I is the input image, I₀ is a result of applying a disconnection operation to input image I, I₀ is a result of applying a connection operation to input image I, and Iᵣₑₛ is an output image with a suppressed background.

6. The method of claim 5, wherein Iᵣₑₛ is calculated for a filter window that is m pixels in width and n pixels in height to produce a first output image Iᵣₑₛ^{v}, and Iᵣₑₛ is calculated for a filter window that is n pixels in width and m pixels in height to produce a second output image Iᵣₑₛ^{h}, wherein n is greater than m.

7. The method of claim 6, wherein detecting whether the first area contains the at least one set of parallel stripes further comprises, for each of the first output image Iᵣₑₛ^{v} and the second output image Iᵣₑₛ^{h}, for all possible lines in a range [−45°, 45° ] calculating a first Hough image Hₕ using a Fast Hough Transform, and for all possible lines in a range [45°, 135° ], calculating a second Hough image Hᵥ using the Fast Hough Transform.

8. The method of claim 7, wherein detecting whether the first area contains the at least one set of parallel stripes further comprises, for each line t in each first Hough image Hₕ and each second Hough image Hᵥ, calculating a sum of squared pixel values.

9. The method of claim 8, wherein the sum of squared pixel values is calculated as:
$$ζ ( t ) = {{\sum }_{s} [ H ( s , t ) ]}^{2} .$$

10. The method of claim 8, wherein the at least one set of parallel stripes is detected when a value of the sum of squared pixel values for any Hough image Hₕ or Hᵥ exceeds a predefined value.

11. The method of claim 1, wherein the one or more areas comprise a second area that includes the boundaries of the document.

12. The method of claim 11, wherein the at least one anomaly comprises a threshold number of matching textures on opposing sides of one or more of the boundaries.

13. The method of claim 12, wherein detecting whether the second area contains the threshold number of matching textures on opposing sides of one or more of the boundaries comprises, for each of the boundaries:
producing a boundary image by selecting an area around the boundary and correcting a bevel of the boundary;
normalizing a brightness of the boundary image;
analyzing a texture of the normalized boundary image using a Fast Hough Transform;
finding coinciding textures on opposing sides of the boundary based on the analysis; and
counting the coinciding textures that are found as the number of matching textures.

14. The method of claim 13, wherein analyzing the texture comprises, in each step of a sliding window across the normalized boundary image, for all possible lines in a range [−45°, 45° ], calculating a first Hough image Hₕ using a Fast Hough Transform, and for all possible lines in a range [45°, 135° ], calculating a second Hough image Hᵥ using the Fast Hough Transform.

15. The method of claim 14, wherein analyzing the texture further comprises, for each line t in each first Hough image Hₕ and each second Hough image Hᵥ, calculating a sum of squared gradients.

16. The method of claim 15, wherein analyzing the texture further comprises, for each line t in each first Hough image Hₕ and each second Hough image Hᵥ:
determining a dominant direction of the texture based on the sum of squared gradients for the line t;
assigning a confidence value to the dominant direction; and
determining whether or not there is a coinciding texture on opposing sides of the boundary based on one or both of the dominant direction and the confidence value.

17. The method of claim 15, wherein the sum of squared gradients is calculated as:
$$ζ ( t ) = {{\sum }_{s} [ H ( s , t ) - H ( s - 1 , t ) ]}^{2} .$$

18. The method of claim 1, wherein the one or more areas comprise a third area that is selected in accordance with the internal structure, and wherein the at least one anomaly comprises an indication of color heterogeneity exceeding a predefined value.

19. A system comprising:
at least one hardware processor; and
software configured to, when executed by the at least one hardware processor,
receive an input image of a document with known boundaries and internal structure,
analyze one or more areas of the document to detect whether any of the one or more areas contain at least one anomaly indicative of a screen capture of a digital copy of the document,
when the at least one anomaly is detected, determine that the input image is an image of the digital copy of the document, and
when the at least one anomaly is not detected, determine that the input image is an image of a physical copy of the document.

20. A non-transitory computer-readable medium having instructions stored thereon, wherein the instructions, when executed by a processor, cause the processor to:
receive an input image of a document with known boundaries and internal structure;
analyze one or more areas of the document to detect whether any of the one or more areas contain at least one anomaly indicative of a screen capture of a digital copy of the document;
when the at least one anomaly is detected, determine that the input image is an image of the digital copy of the document; and
when the at least one anomaly is not detected, determine that the input image is an image of a physical copy of the document.
